(19) United States
(12) Patent Application Publication
(10) Pub. No.: US 2025/0349455 A1
(43) Pub. Date: Nov. 13, 2025

(54) CASINGS FOR ASSEMBLING FERRITE CORES TO CABLES

(71) Applicant: Fair-Rite Products Corp., Wallkill, NY (US)

(72) Inventor: Joseph P. Custy, Pine Bush, NY (US)

(73) Assignee: Fair-Rite Products Corp., Wallkill, NY (US)

(21) Appl. No.: 19/186,250

(22) Filed: Apr. 22, 2025

Related U.S. Application Data
(60) Provisional application No. 63/646,280, filed on May 13, 2024.

(51) Int. Cl. H01F 27/26; H01F 27/02

(52) U.S. Cl. CPC H01F 27/266; H01F 27/02; H01F 27/263

(57) ABSTRACT

A casing assembly is provided for holding a split ferrite core on at least one conductor. The casing assembly has first and second identical casing halves. Each casing half has first and second opposed side walls with inner surfaces that face toward one another and outer surfaces that face away from one another. First and second locks are formed on the outer surface of the first side wall of each casing half, and first and second hinge structures are formed on the outer surface of the second side wall of each casing half. The hinge structures are configured so that the first hinge structure of one casing half rotatably engages the second hinge structure of the other casing half. The first and second locks are disposed and configured so that first lock of one casing half is releasably lockable with the second lock of the other casing half.

### CROSS-REFERENCE TO RELATED APPLICATION

This application claims priority to U.S. Provisional Patent Application No. 63/646,280, filed May 13, 2024, the entire disclosure of which is incorporated herein by reference.

### BACKGROUND

Field of the Invention. This disclosure relates generally to a casing for holding a split core, such as a split ferrite core, at a specified position around one or more cables so that the core can suppress electric noise associated with the current flowing through the one or more cables.

Related Art. A ferrite is a ceramic-like material that typically comprises ferric oxide and another metal. Ferrites have been used for decades to suppress electronic noise associated with a current flowing through a cable or other conductor and/or to ensure that electronic noise generated elsewhere does not affect a signal carried through a cable or other conductor.

Many electric devices use a split ferrite core having two opposed halves that are mounted around one or more cables. A mechanical device then is required to hold the opposed halves of the split ferrite core in position on the cable or wire.

Resin casings are used widely for holding the opposed halves of a ferrite core in position on a cable. For example, U.S. Pat. No. 5,900,796 was assigned to the assignee of the subject application and discloses a casing with two halves connected to one another by hinges. Each half of the casing has a concave surface configured to receive one half of the split ferrite core. The halves of a split ferrite core are positioned in the respective halves of the casing. A first of the casing halves with a first half of the split ferrite core mounted therein is positioned to surround half of the cable at a selected position along the cable. The second casing half with the second half of the split ferrite core then is rotated about the hinges to enclose a selected section of the cable between the opposed halves of the split ferrite core. The opposed halves of the casing have locks that are configured to hold the halves of the casing in their closed position and to retain the split ferrite core around the cable. Additionally, the opposed halves of the casing typically are configured to grip the cable for holding the ferrite core and the casing at a fixed position along the cable.

Casings of the type described in U.S. Pat. No. 5,900,796 still are used widely. Many such products have the opposed halves of the casing connected unitarily to one another by living hinges in the form of flexible strips that connect the opposed halves of the casing to one another. However, the requirement for flexible hinges limits the types of resins that can be used to form the casings to those resins that can provide the required flexibility for the hinges. Additionally, the molds used to create the opposed casings that are joined unitarily by living hinges can be extremely complicated.

Some ferrite cores must be used in environments that are subject to vibration and/or elevated temperatures. For example, ferrite cores often can be used in off-road vehicles, military vehicles and in other locations that are subject to vibration and shock Many injection-moldable thermoplastics are not suitable for long time exposure to vibration and/or heat.

Accordingly, an object of the invention is to provide a casing for holding a split ferrite core on one or more cables.

Another object of the invention is to provide a casing that does not have or require a living hinge that is molded unitarily with the opposed casing halves.

Still another object of the invention is to provide a hinged casing that avoids inventory management problems associated with casings having two differently configured casing halves.

A further object of the invention is to provide a casing capable of gripping cables that pass through the ferrite core around which the casing is mounted.

An additional object of the invention is to provide a hinged casing that can be held in a position where the casing halves are separated from one another by 180° for mounting the halves of the ferrite core.

Another object of the invention is to provide a casing configured to bias the halves of the split ferrite core against one another and to prevent sliding movement of the split ferrite cores relative to one another.

Still another object of the invention is to provide a casing that can retain wire wraps for holding the casing and the ferrite core in a fixed position on one or more cables.

### SUMMARY OF THE INVENTION

One aspect of the invention relates to an assembly of a casing and a split ferrite core that can be mounted on one or more cables or wires. Another aspect of the invention relates to an assembly that comprises two identical casing halves that can be mounted to the opposed halves of a split ferrite core. The identical casing halves are connectable hingedly to one another and, when connected, can be rotated between an opened position for receiving the respective halves of the split ferrite core and a closed position where the identical halves of the split ferrite core are retained securely in face-to-face contact. The casing that is in the closed position also prevents the opposed halves of the split ferrite core from sliding relative to one another in directions parallel to a plane along which the halves of the split ferrite core are in facing contact. The configuration of the identical casings can be made with molds that are of simple construction and can be connected easily to one another. Furthermore, this design greatly simplifies inventory management complications that can exist with designs that have two differently configured casing halves. The absence of a flexible living hinge enables the use of moldable materials that are well suited for use in high vibration environments, high heat environments and low heat environments without risking longtime vibration related damage or temperature related deterioration of the casing. For example, the casing halves can be made of nylon.

Each casing half has a convex exterior and a concave interior. Each casing half may have a base wall, opposite first and second side walls and opposite first and second end walls that may be substantially parallel to one another and substantially perpendicular to the side walls. Parts or edges of the side walls and end walls that are farthest from the base wall may lie in common plane.

Concave edge regions may be formed on the end walls of the casing halves and are dimensioned to accommodate a cable or plural cables positioned side-by-side. The concave edge regions may be characterized by pointed cable grips that are configured to bite into the insulation on the cable positioned in the concave edge regions.

Resiliently deflectable positioning tabs may be cantilevered from the base wall of each casing half and extend away from one another into curved transitions between of the base wall and the side walls. The positioning tabs project slightly inwardly relative to the adjacent concave surface areas. However, the positioning tabs can be biased resiliently outward in response to forces exerted on or by the ferrite core. The positioning tabs will bias a ferrite core half in one casing half toward the ferrite core half in an identical and opposed casing half. As a result, opposed planar regions of the opposed ferrite cores will be held in contact with one another, and concave central regions of the two opposed ferrite cores will be biased into engagement with one or more cables between the two ferrite core halves. The concave curved shapes and the outward cantilevered direction of the positioning tabs also helps to resist lateral movement of the ferrite core halves relative to one another, such as lateral sliding movement.

End positioning tabs may project in from the end walls into the concave area of the casing half and may comprise sloped or convex rounded surfaces that help to guide a ferrite core toward a longitudinal central part of the concave area of the casing half. The end positioning tabs can be formed as rounded beads or bumps.

Core locking tabs of some embodiments project toward one another from positions on the end walls centrally between the sidewalls. At least one locking tab may be cantilevered from a leading end of a resiliently deflectable pedestal and may have a sloped upper surface and a lower locking surface aligned substantially parallel to the base wall. A distance between the locking surfaces of the core locking tabs and the base wall is selected to hold a ferrite core securely adjacent the base wall. Additionally, a lateral dimension of each core locking tab measured parallel to a distance between the sidewalls is selected so that the locking tabs can fit into locking recesses formed in the ferrite cores.

In some embodiments, a locking latch projects from the exterior surface of the casing half and may project beyond the planar edge in a direction perpendicular to the edge. The locking latch may have an inverted U-shape that defines a locking opening. A locking projection may project out from the first side wall and has a sloped surface adjacent the edge to generate deflection of the locking latch on another identical casing half. The locking projection is dimensioned to fit into the locking opening. Thus, the locking projection on one casing half can be snapped into releasable locked engagement with the locking opening of a locking latch on another identical casing half.

Two hinge pin supports extend out from the second side wall and project to a position spaced above the planar edge, and a hinge pin extends between the hinge pin supports and at a position laterally outward from the second side wall and above the edge. A hinge pin engaging structure projects out from the second side wall at a position near the second end wall and has a concave pin engaging recess or receptacle that faces down in a direction towards the convex side of the casing half. The casing half also has rotation stop structures projecting laterally out from positions on the second side wall near opposite ends of the hinge pin engaging structure. The rotation stop structures are disposed and configured to limit rotation of the hingedly connected casing halves to 180° where the base walls of the two hingedly connected casing halves lie in a common plane.

Two of the identical casing halves can be assembled by positioning the convex surfaces of the casing halves on a supporting surface and with the casing halves oriented so that the second side walls of the casing halves are substantially adjacent to one another while the two first side walls face away from one another. The two identical casing halves then are positioned so that the hinge pins align with the concave pin engaging recesses or receptacles. The hinge pins then are snapped into the concave pin engaging recesses or receptacles so that the two casing halves are connected hingedly to one another. Additionally, the rotation stop structures engage the hinge pin supports of the opposed casing half to hold the casing halves in a position where the edges lie in a common plane and the base walls lie in a common plane. The two casing halves can be rotated relative to one another into a closed position but cannot be rotated farther away from one another more than 180° from the closed position. Thus, the two casing halves are in positions that are rotated substantially precisely from one another by 180°.

The invention will be described below with respect to certain preferred embodiments. However, the invention defined by the claims is not limited to the illustrated embodiments or the description of those embodiments.

### BRIEF DESCRIPTION OF THE DRAWINGS

FIG. 1 is a perspective view showing the convex exterior of one of two identical casing halves.

FIG. 2 is a first perspective view of the casing half of FIG. 1 showing the concave interior of the casing half as seen from a first side of the casing half.

FIG. 3 is a second perspective view of the casing half of FIGS. 1 and 2 showing the concave interior of the casing half as seen from the second side of the casing half.

FIG. 4 is an elevation view showing the concave interior of FIGS. 2 and 3.

FIG. 5 is a side elevational view showing the second side of the casing half.

FIG. 6 is an elevational view showing a first end of the casing.

FIG. 7 is an end elevational view showing a second end of the casing half.

FIG. 8 is a longitudinal cross-sectional view of the casing half taken along line 8-8 in FIG. 2.

FIG. 9 is a perspective view showing two of the casing halves of FIGS. 1-7 hingedly connected to one another in a partly opened condition and having opposed halves of a split ferrite core mounted respectively in the casing halves.

FIG. 10 is an exploded perspective view showing an alternate embodiment of two identical casing halves hingedly connected to one another in a partly opened position and with the split ferrite core disposed for mounting into the casing halves.

FIG. 11 is a perspective view showing the casing halves of FIG. 10 hingedly connected to one another and disposed in a partly opened condition with the assembled ferrite core mounted in one of the identical casing halves.

FIG. 12 is a perspective view of the casing halves of FIG. 10 closed around the split ferrite core.

FIG. 13 is a top plan view of the assembled casing illustrated in FIGS. 10-12.

FIG. 14 is a cross-section taken along line 14-14 in FIG. 13.

FIG. 15 is a cross-section taken along line 15-15 in FIG. 13.

FIG. 16 is a cross-section taken along line 16-16 in FIG. 13.

### DETAILED DESCRIPTION

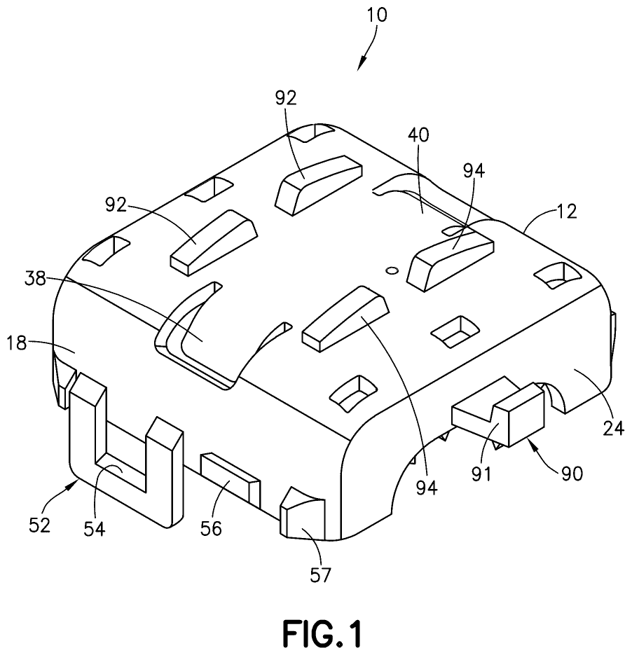

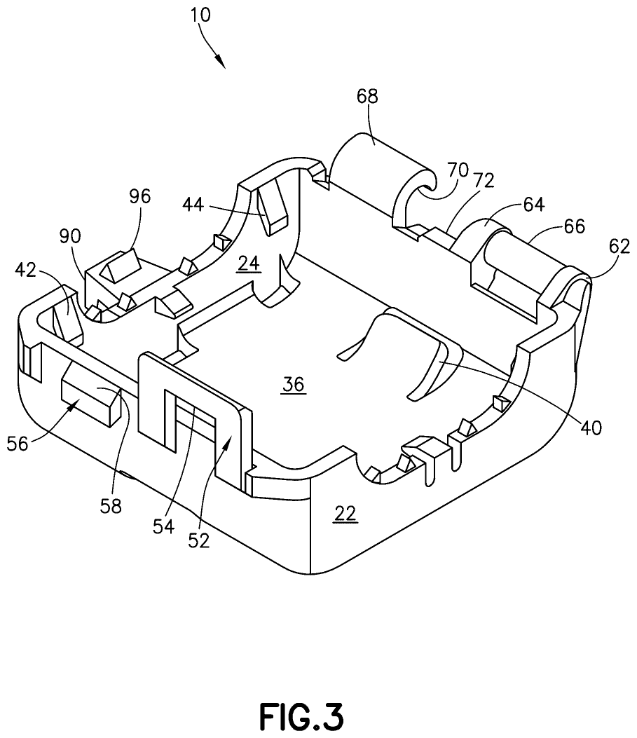

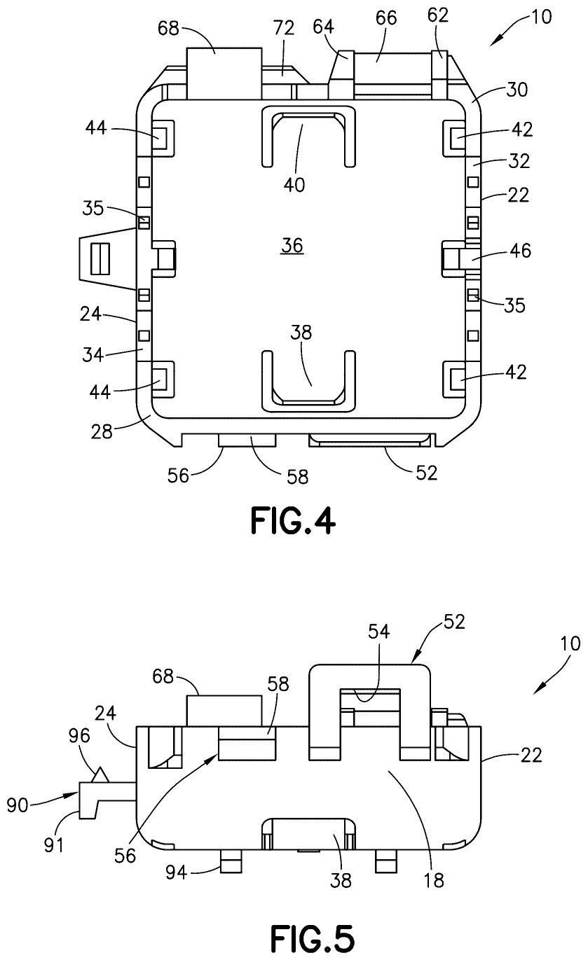

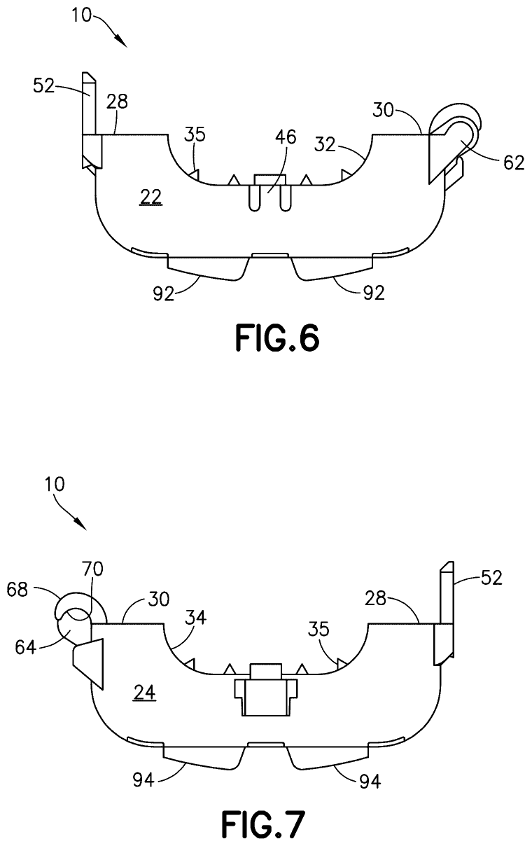

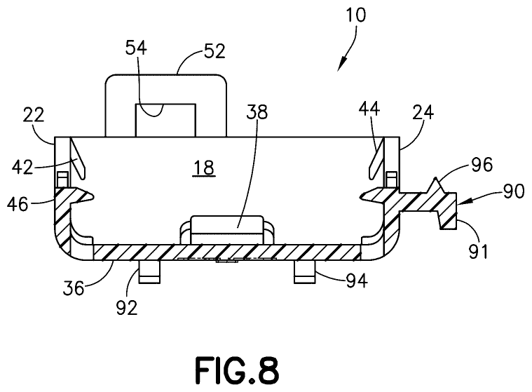

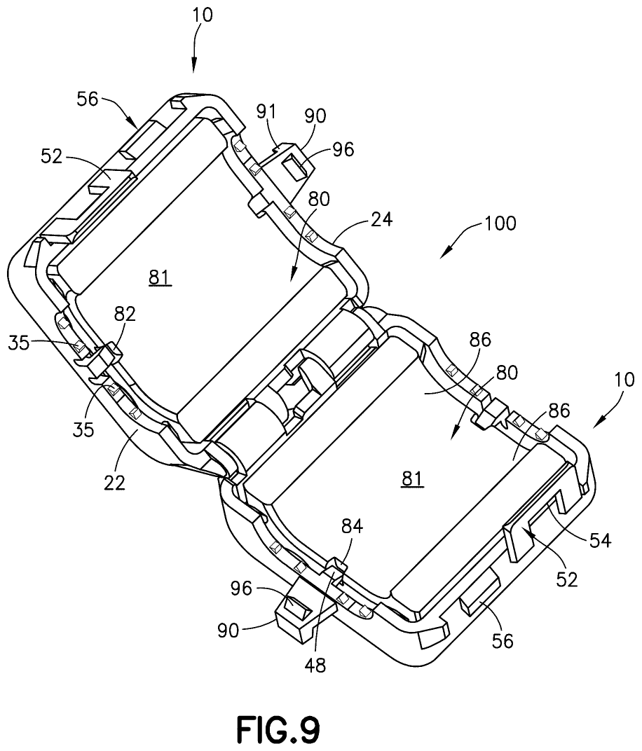

A casing half in accordance with one embodiment of the invention is identified generally by the numeral 10 in FIGS. 1-9. Two identical casing halves 10 can be assembled together to form a casing 100, as illustrated in FIG. 9. Each casing half is formed from nylon or polyamide, such as PA66, to provide enhanced strength for those environments that require a more robust structure than is provided by most thermoplastic resins. A nylon casing half is particularly well suited for use in automobiles, as an example, where there is high vibration and periodic cycles between very hot and very cold temperatures.

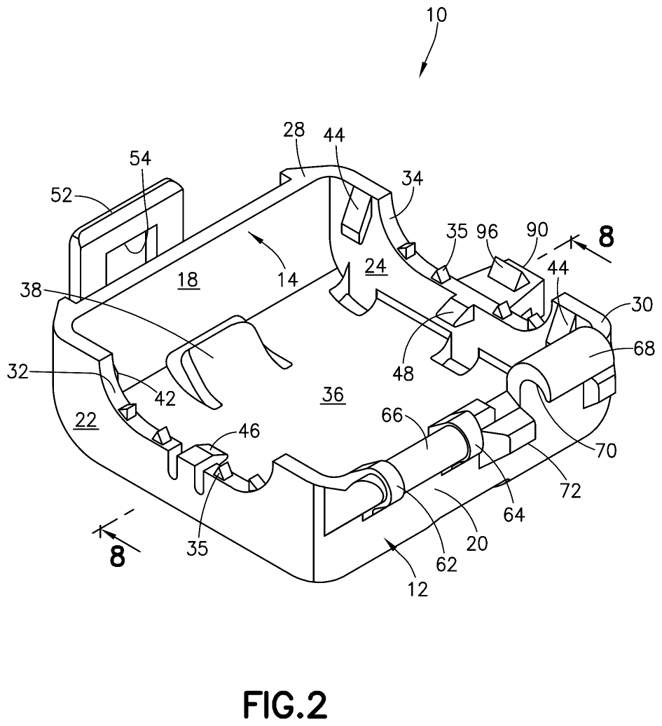

Each casing half 10 has a convex exterior 12, as illustrated in FIGS. 1 and 5-7, and a concave interior 14 as illustrated in FIGS. 2-4, 8 and 19. Each casing half 10 also has opposite first and second side walls 18 and 20. Upper parts of the side walls 18 and 20 are substantially planar and substantially parallel to one another in this embodiment. Each casing half 10 further has opposite first and second end walls 22 and 24 that are substantially parallel to one another and substantially perpendicular to the side walls 18 and 20 in this embodiment.

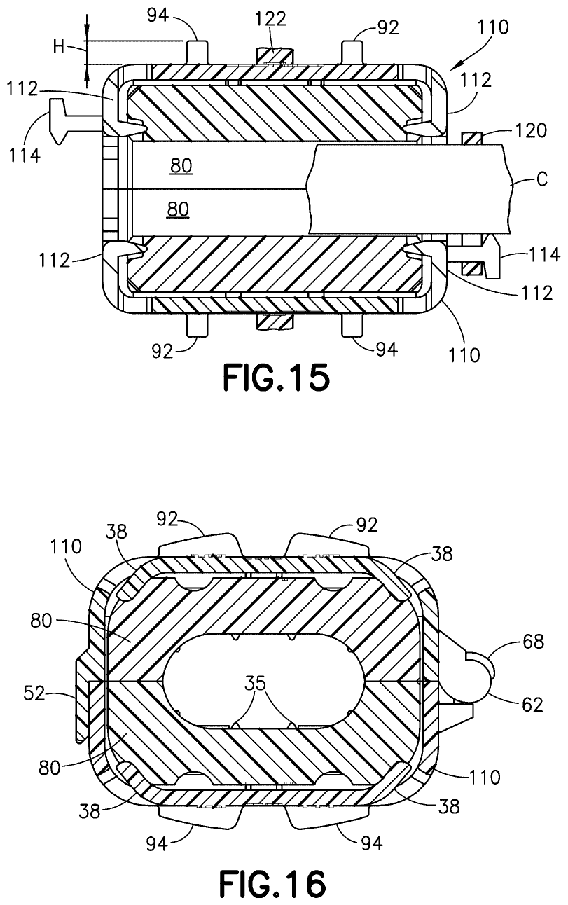

A substantially planar edge 28 extends between the convex exterior 12 and the concave interior 14 at a free edge region the first side wall 18 and continues into areas adjacent to the first and second longitudinal end walls 22 and 24. Similarly, a substantially planar edge 30 extends between the convex exterior 12 and the concave interior 14 at areas adjacent the second side wall 20 of the casing half 10 and continues into areas adjacent to the first and second longitudinal end walls 22 and 24. The planar edges 28 and 30 are coplanar with one another. A first concave edge region 32 is formed at the first end wall 22 of the casing half 10 and extends between the first planar edge region 28 and the second planar edge region 30. Similarly, a second concave edge region 34 is formed at the second end wall 24 and extends between the first planar edge region 28 and the second planar region 30. The first and second concave edge regions 32 and 34 are dimensioned to accommodate two cables (C in FIG. 15) that are positioned side-by-side. The concave edge regions 32 and 34 are characterized by pointed cable grips 35 that are configured to bite into the insulation on the cable that will pass through the casings 10, as explained further below.

Areas of the first and second side walls 18 and 20 of the casing half 10 that are adjacent the respective edges 28 and 30 are substantially planar and parallel to one another. Areas of the respective side walls 18 and 20 farther away from the planar edges 28 and 30 curve toward one another to define transitions that merge into a base wall 36. The base wall 36 is substantially planar and is aligned substantially parallel to the planar edges 28 and 30.

Positioning the split ferrite cores in the respective casing halves without relative movement is an important objective of the casing. Accordingly, resiliently deflectable positioning tabs 38 and 40 are cantilevered in opposite directions from the base wall 36 into the curved transition portions and toward the respective side walls 18 and 20. The positioning tabs 38 and 40 project slightly inwardly relative to the adjacent concave surface areas of the transitions to the respective first and second side walls 18 and 20. However, the positioning tabs 38 and 40 can be biased resiliently outward in response to forces exerted on or by the ferrite core. The positioning tabs 38 and 40 will bias a ferrite core half in one casing half 10 toward the ferrite core half mounted in an identical and opposed casing half 10, and the positioning tabs 38, 40 also will resist lateral or transverse sliding movement between the opposed ferrite core halves, as explained further below. As a result, planar lateral side regions of the opposed ferrite cores 80 will be held in contact with one another, and concave central regions 81 of the two opposed ferrite cores 80 will be biased into central positions in the respective casing halves 10 and in engagement with one or more cables sandwiched between the two ferrite core halves 80. Two end positioning tabs 42 project from the first end wall 22 into the concave area 14 of the casing half 10, and two end positioning tabs 44 project from the second end wall 24 into the concave area 14 of the casing half 10. Sloped surfaces are formed on sides of the respective end positioning tabs 42, 44 that face away from the base wall 36. The sloped surfaces of the respective positioning tabs 42 and 44 guide a ferrite core 80 into the concave area 14 of the casing halve 10. A minimum distance between each positioning tabs 42 and the opposite positioning tabs 44 conforms to the length of the ferrite core 80 so that the positioning tabs 42 and 44 prevent longitudinal movement of the ferrite cores in the respective casing half 10. The end positioning tabs 42, 44 can be formed as rounded beads or bumps.

First and second core locking tabs 46 and 48 project toward one another from positions on the respective first and second end walls 22 and 24 centrally between the sidewalls 12 and 14. The locking tab 46 is cantilevered from a leading end of a resiliently deflectable pedestal and has a sloped upper surface and a lower locking surface aligned substantially parallel to the base wall 36. The second core locking tab 48 of this embodiment is not at a leading end of a deflectable pedestal, but rather projects directly inward from the second end wall 24. The second core locking tab 48 has a sloped upper surface and a lower locking surface aligned substantially parallel to the base wall 36. The distance between the locking surfaces of the core locking tabs 46, 48 and the base wall 36 is selected to lock a ferrite core securely adjacent the base wall 36. Additionally, lateral dimensions of the core locking tabs 46 and 48 measured parallel to a distance between the sidewalls 18 and 20 is selected so that the locking tabs 46 and 48 can fit into locking recesses formed in the ferrite cores. In other embodiments, as explained further below, both core locking tabs 46 and 48 will be at leading ends of resiliently deflectable pedestals.

A locking latch 52 projects from the exterior surface 12 of the casing half 10 at a position on the first side wall 18 closer to the first end wall 22 than to the second end wall 24. The locking latch 52 projects beyond the planar edge 28 in a direction perpendicular to the edge 28 and defines a substantially U-shape. A concave region of the U-shaped locking latch 52 forms a locking opening 54 adjacent to the edge 28, as shown in FIGS. 1-3, 5, 8 and 9. A locking projection 56 projects out from the first side wall 18 at a position between the locking latch 52 and the second end wall 24. The locking projection 56 has a sloped surface adjacent the edge 28 to generate deflection of the locking latch 52 on another identical casing half 10. A dimension of the locking projection 56 measured parallel to a length dimension of the casing half 10 extending between the first and second end walls 22 and 24 is slightly smaller than a corresponding dimension of the locking opening 54. Additionally, a height dimension of the locking projection 56 measured perpendicular to the plane formed by the planar edges 28, 30 is slightly smaller than a height dimension of the locking opening 54 measured perpendicular to the plane formed by the planar edges 28, 30 As a result, the locking projection 56 on one casing half 10 can be snapped into releasable locked engagement with the locking opening 54 of a locking latch 52 on another identical casing half 10, as explained further below. A projection 57 is formed on the outer surface of the first side wall between the locking projection 56 and the second end wall 24 and guides the locking latch 52 of another identical casing half 10 into locking engagement with the locking projection 56

Two hinge pin supports 62 and 64 extend out from the second side wall 20 and up to a position spaced above the planar edge 30. The hinge pin supports 62 and 64 are closer to the first end wall 22 than to the second end wall 24. A hinge pin 66 extends between the hinge pin supports 62, 64 in a direction parallel to the second side wall 20 and is at a position laterally outward from the second side wall 20 and above the edge 30. A hinge pin engaging structure 68 projects out from the second side wall 20 at a position near the second end wall 24 and has a concave pin engaging surface 70 that faces down in a direction towards the convex side 12 of the casing half 10. The free end of the pin engaging structure 68 may be curved, thinned or sloped to facilitate an outward deflection of the hinge pin engaging structure 68 followed by resilient rotational engagement with a hinge pin 66, as explained below. The casing half 10 also is characterized by rotation stop structures 72 projecting laterally out from positions on the second side wall 20 near opposite ends of the hinge pin engaging structure 68.

Two of the identical casing halves 10 can be assembled with one another by positioning the convex surfaces 12 of the casing halves 10 on a supporting surface and with the casing halves 10 oriented so that the second side walls 20 of the two casing halves 10 are substantially adjacent from one another while the two first side walls 18 face away from one another. The two identical casing halves 10 then are positioned so that the hinge pins 66 of two casing halves 10 align with the concave pin engaging surface 70. The respective hinge pins 66 then are snapped into the concave pin engaging surfaces 70 so that the two casing halves 10 are connected hingedly to one another. Additionally, the rotation stop structures 72 of the two casing halves 10 engage the hinge pin supports 62, 64 of the opposed casing half 10 to hold the casing halves 10 in a position where the edges 28, 30 lie in a common plane. The two casing halves 10 can be rotated relative to one another into a closed position but cannot be rotated farther away from one another. Thus, the two casing halves 10 are in positions that are rotated substantially precisely from one another by 180°.

The two hingedly connected casing halves 10 form a casing assembly 100 as illustrated in FIG. 9. Two identical split ferrite cores 80 can be mounted respectively in two the casing halves 10. In this regard, each split ferrite core 80 has a concave surface 82 that is visible in FIG. 9 and an opposed convex surface that is nested into the concave surface 14 of the respective housing half 10. Opposite ends of each split ferrite core 80 are formed with locking notches 82 and 84 that are positioned to face the respective first and second end walls 22 and 24 respectively. The split ferrite cores 80 are mounted respectively into the concave faces 14 of the casing halves 10. This mounting process can be carried out with the convex surfaces 12 of the casing halves 10 supported on a horizontal surface and with the hingedly connected casing halves rotated into position spaced 180° from one another. The positioning tabs 42, 44 of the casing halves 10 move the ferrite cores 80 into proper positions relative to the end walls 22 and 24. Further pushing forces exerted on the split ferrite cores 80 will cause the core locking tabs 46 and 48 to deflect resiliently away from one another sufficiently for the cores 80 to be inserted into the respective casing half 10. Sufficient insertion of the cores 80 will enable the core locking tabs 46 and 48 to lock into engagement in the notches 82 and 84 in the respective split cores 80. Cables then can be positioned in the elongated cable grooves 86 formed in each split ferrite core 80. The cables will extend beyond the ferrite core in opposite directions and will engage in the concave edge regions 32, 34 of the corresponding casing half 10. The casing halves 10 then will be rotated into a closed position where the locking latches 52 engage with the locking projections 56 to hold the casing 100 in the closed position. In this closed position, the positioning tabs 38 and 40 bias the split ferrite cores 80 against one another and resist lateral sliding movement of the split ferrite cores 80 relative to one another due to the inwardly curved shapes of the positioning tabs 38, 48 and their opposite cantilevered directions. The positioning tabs 38 are positioned symmetrically relative to the locking latches 52 and the locking projections 56 to achieve a balancing of forces on the ferrite cores 80. Similarly, the positioning tabs 40 are disposed symmetrically relative to the hinge pins 66 and the hinge pin engaging structures 68 to achieve a balancing of forces on the ferrite core 80. The positioning tabs 42 and 44 and the core locking tabs 46 and 48 also are disposed to achieve balanced forces on the ferrite cores 80. Additionally, the projections 35 that project from the concave edge regions 32 and 34 of the respective end walls 22 and 24 bite into the insulation of the cables and thereby prevent relative longitudinal movement between the cables and the casing 100.

Some ferrite cores are mounted at regions that are subject to vibration, such as those ferrite cores that are used in automotive applications, especially offroad vehicles and military vehicles. Cable ties or wraps are helpful for maintaining a fixed position of the ferrite core on the cables. For this purpose, each casing half 10 of this embodiment is formed with a cable tie projection 90 projecting from the second end wall 24 in a direction away from the first end wall. The projection 90 is substantially L-shaped and has a leg 91 projecting toward the convex side 12 of the casing half 10. The leg 91 is spaced from and substantially parallel to the end wall 24, and a cable tie can be wrapped around the cable tie projection 90 at a position trapped between the leg 91 and the side wall 24. A cable gripping blade 96 projects from a side of the projection 90 opposite the leg 91. The cable gripping blade 96 extends transverse to the cable and bites into the insulation of the cable as the wire wrap is tightened about the cable and the cable tie projection to resist movement of the cable. Additionally, the convex surface 12 of each casing half 10 is formed with projections 92 and 94. The projections 92 are closer to the end wall 22 and the projections 94 are closer to the end wall 24. Cable ties can be positioned between the first projections 92 and between the second projections 94 and further can be wrapped around a nearby structure for preventing relative movement of the ferrite core. Additionally, projecting ends of the projections 92 and 94 lie in a common plane that is parallel to the plane of the base wall 36 to define a stable support for the casing half 10 on a supporting surface when the ferrite core halves 80 are being urged into the corresponding casing half 10.

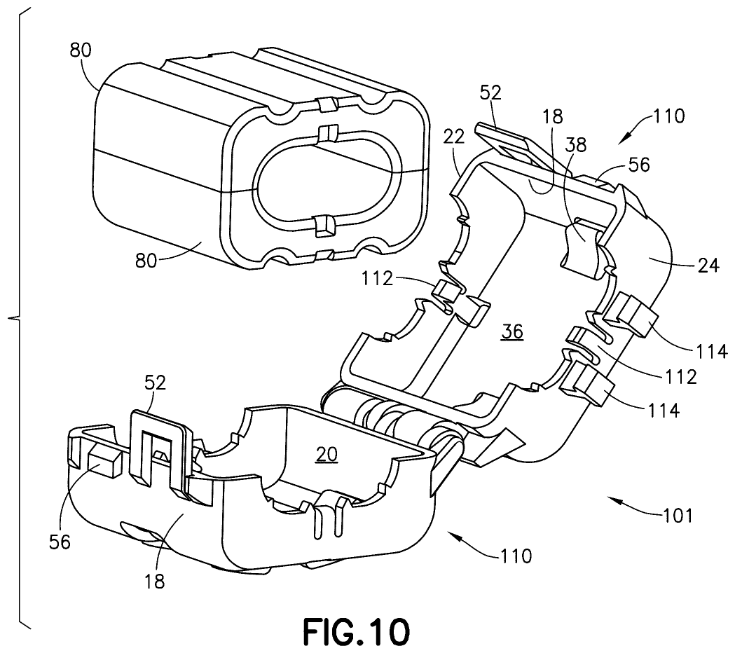

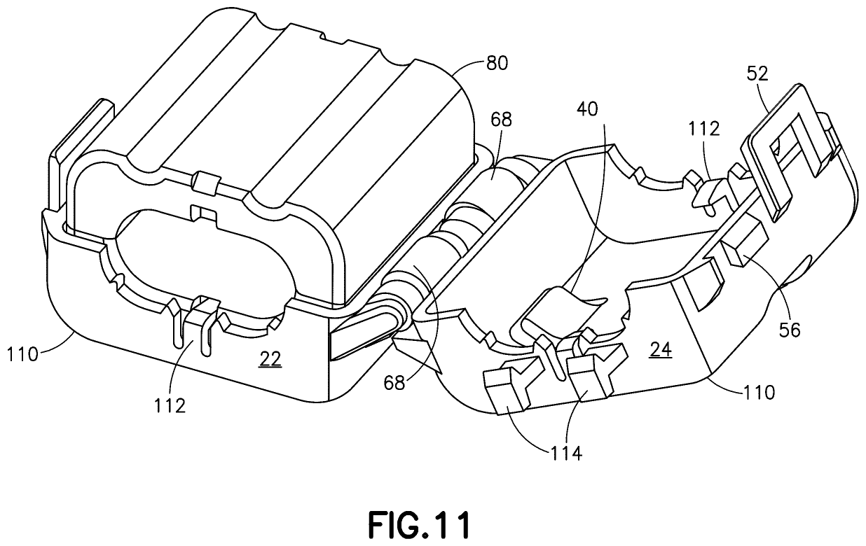

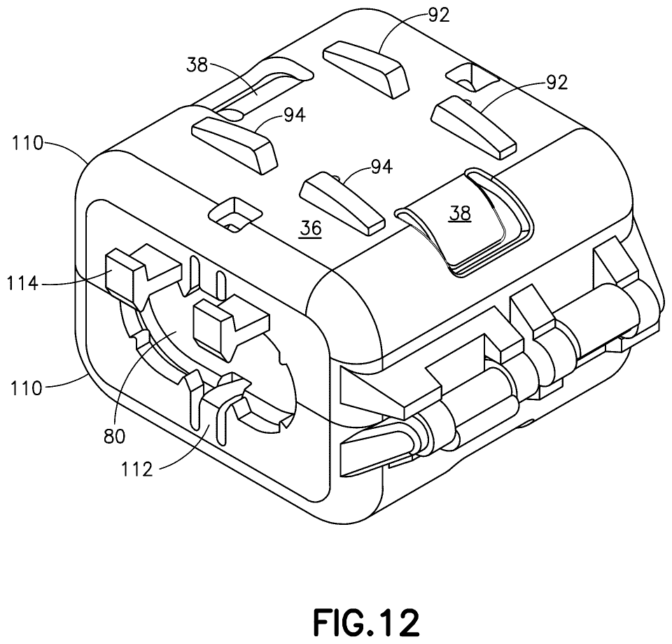

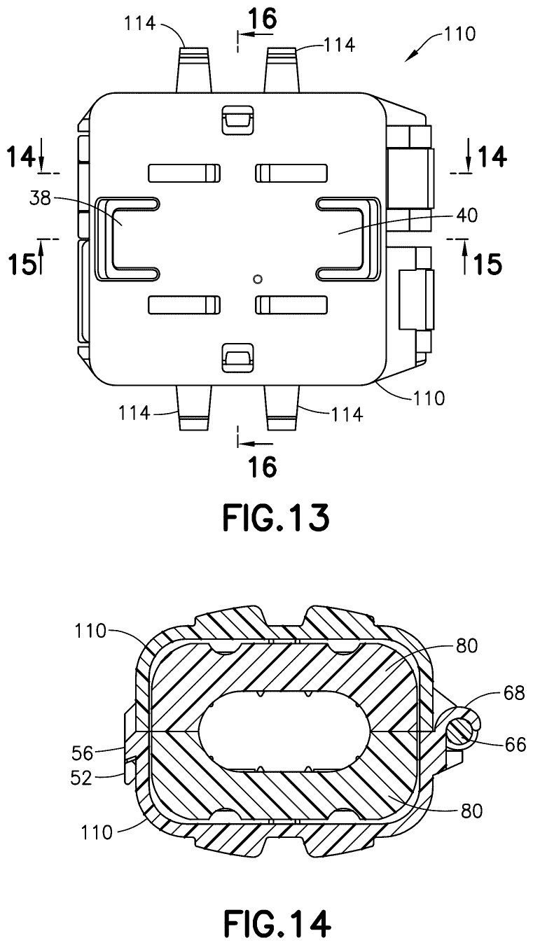

An alternate case assembly is identified generally by the numeral 101 in FIGS. 10-15 and comprises two identical cases 110. Each case 110 differs from the cases 10 described above in two respects. First, resiliently deflectable core locking tabs 112 are cantilevered from both opposite end walls 22 and 24 of each case 110, rather than having a more rigid core locking tab at one end as in the previous embodiment. The provision of a resiliently deflectable core locking tab 112 at each end of each case 110 provides balanced longitudinal positioning forces and retention forces on each end of each split ferrite core 80. Second, two end wire wrap projections 114 are formed at the first end 24 of each case 110 so that the case assembly 101 formed from two such cases 110 has two end wire wrap projections 114 at each end. Thus, the assembly comprised of the cables C, the split ferrite cores 80 and the case assembly 101 can be held more securely to a nearby structure, such as a nearby wire bundle.

The alternate case assembly 101 of this embodiment also has projections 92 and 94 from the base wall 36 for retaining a wire wrap 122, as shown in FIG. 15, in a manner similar to the first embodiment. The wire wrap 122 can redundantly hold the case assembly 101 in its closed position and the projections 92, 94 and 114 prevent the wire wraps 120, 122 from separating from the case assembly 101 (or 100). This secure retention of wire wraps 120, 122 can be helpful when the ferrite cores 80 and the case assembly 100 or 101 are used in a high vibration environment, such as in an off-road vehicle or a military vehicle. The projections 92, 94 also have equal projecting heights H from the base wall 36 to provide a stable support when the case assembly 101 is closed, as in FIG. 15, or when the cases 110 are rotated 180° into the fully open position in which the split ferrite cores 80 are inserted into the respective cases 110.

Features of the case assembly 110 that are substantially the same as the features described above with respect to the case 10 are identified by the same reference numerals in FIGS. 10-16 as used in FIGS. 1-9 and are not described again.

While the invention has been described with respect to certain preferred embodiments, it is apparent that various changes can be made without departing from the scope of the invention as defined by the appended claims.

1. A casing assembly for holding a split ferrite core on at least one conductor, the casing assembly having first and second casing halves, each of the casing halves comprising:
a base wall;
first and second opposed side walls projecting away from the base wall, the side walls having inner surfaces that face toward one another and outer surfaces that face away from one another, first and second locks formed on the outer surface of the first side wall of each casing half, and first and second hinge structures formed on the outer surface of the second side wall of each casing half, wherein
the first and second hinge structures are disposed and configured so that first hinge structures of one of the casing halves is rotatably engageable with the second hinge structure of the other of the casing halves; and
the first and second lock structures are disposed and configured so that first lock structure of one of the casing halves is releasably lockable with the second lock structure of the other of the casing halves.

2. The casing assembly of claim 1, wherein the first and second casing halves are identical.

3. The casing assembly of claim 2, wherein each of the casing halves has a concave interior with first and second inwardly concave curved transition walls extending respectively from the first and second side walls to opposite sides of the base wall, resiliently deflectable first and second positioning tabs cantilevered in opposite directions from opposite side regions of the base wall and being curved to project inward of the respective curved transition walls.

4. The casing assembly of claim 1, further comprising opposite first and second end walls connected to opposite ends of the base wall and extending between the first and second side walls.

5. The casing assembly of claim 4, further comprising end positioning tabs projecting from inwardly facing surfaces of the first and second end walls and being dimensioned for engaging opposite ends of the split ferrite core and resisting movement of the split ferrite core toward and away from the first and second end walls.

6. The casing assembly of claim 4, further comprising first and second core locking tabs projecting toward one another from opposed inwardly facing surfaces of the first and second end walls, each of the first and second core locking tabs having an upper surface that is sloped down to approach the base wall at farther distances from the respective end wall and a lower surface that is aligned for engaging a surface of a split ferrite core.

7. The casing assembly of claim 6, wherein the first end wall has a first slit between the first core locking tab and the first side wall and a second slit between the core locking tab and the second side wall, the first and second slits facilitating resilient deflection of the first core locking tab away from the second core locking tab.

8. The casing assembly of claim 6, wherein the outer surface of the second side wall has stop projections in proximity to the first and section hinge structures, the stop projections on the first housing half being disposed and dimensioned to limit rotation of the first and second housing halves to 180° from a closed position of the first and second housing halves.

9. The casing assembly of claim 4, wherein each of the casing halves has a convex outer surface with at least one first projection and at least one second projection, the at least one first projection being between the first end wall and the at least one second projection, and the at least one second projection being between the second end wall and the at least one first projection, the at least one first projection being spaced from the at least one second projection accommodating a cable tie between the at least one first projection and the at least one second projection.

10. The casing assembly of claim 4, further comprising at least one cable tie projection cantilevered from the second end wall in a direction away from the first end wall, a cable tie retention tab extending from a location on the cable tie projection spaced from the second end wall and extending in a direction away from an open side of the casing half.

11. The casing assembly of claim 10, wherein the at least one cable tie projection has a cable biting projection on a side of the cable tie projection opposite the cable tie retention tab, the cable biting projection being configured for biting into cable insulation of a cable passing through the casing assembly.

12. An electronic noise suppression assembly for suppressing noise at one or more cables, the assembly comprising:
a ferrite core assembled around a longitudinal section of at least one cable; and
a casing assembly having first and second identical casing halves configured to be assembled around the ferrite core, each of the casing halves having opposite first and second side walls, first and second hinge structures formed on the second side wall of each of the casing halves, the first hinge structures being configured to rotatably engage the second hinge structures to form two hinges that enable the casing halves to be rotated from a closed position where the casing halves are closed around the assembled ferrite core members and an open position where the split ferrite core members can be inserted into or removed from the casing halves, first and second locks formed on the outer surface of the first side wall of each casing half, the first and second lock structures being disposed and configured so that first lock structure of one of the casing halves is releasably lockable with the second lock structure of the other of the casing halves to hold the casing halves assembled around the ferrite core

13. The casing assembly of claim 12, wherein each of the casing halves has a base wall and first and second inwardly concave curved transition walls extending respectively from the first and second side walls to opposite sides of the base wall, resiliently deflectable first and second positioning tabs cantilevered in opposite directions from opposite side regions of the base wall and being curved to project inward of the respective curved transition walls.

14. The casing assembly of claim 13, further comprising opposite first and second end walls connected to opposite ends of the base wall and extending between the first and second side walls.

15. The casing assembly of claim 14, further comprising end positioning tabs projecting from inwardly facing surfaces of the first and second end walls and being dimensioned for engaging opposite ends of the ferrite core and resisting movement of the ferrite core toward and away from the first and second end walls.

16. The casing assembly of claim 14, further comprising first and second core locking tabs projecting toward one another from opposed inwardly facing surfaces of the first and second end walls, each of the first and second core locking tabs having an upper surface that is sloped down to approach the base wall at farther distances from the respective end wall and a lower surface that is aligned for engaging a surface of a ferrite core.

17. The casing assembly of claim 16, wherein the first end wall has a first slit between the first core locking tab and the first side wall and a second slit between the core locking tab and the second side wall, the first and second slits facilitating resilient deflection of the first core locking tab away from the second core locking tab.

18. The casing assembly of claim 16, wherein the outer surface of the second side wall has stop projections in proximity to the first and second hinge structures, the stop projections on the first casing half being disposed and dimensioned to limit rotation of the first and second casing halves to 180° from a closed position of the first and second casing halves.

19. The casing assembly of claim 14, wherein each of the casing halves has a convex outer surface with at least one first projection and at least one second projection, the at least one first projection being between the first end wall and the at least one second projection, and the at least one second projection being between the second end wall and the at least one first projection, the at least one first projection being spaced from the at least one second projection for accommodating a cable tie between the at least one first projection and the at least one second projection.

20. The casing assembly of claim 14, further comprising at least one cable tie projection cantilevered from the second end wall in a direction away from the first end wall, a cable tie retention tab extending from a location on the cable tie projection spaced from the second end wall and extending in a direction away from an open side of the casing half.
